(19) United States
(12) Patent Application Publication
(10) Pub. No.: US 2010/0198685 A1
(43) Pub. Date: Aug. 5, 2010

(54) PREDICTING WEB ADVERTISEMENT CLICK SUCCESS BY USING HEAD-TO-HEAD RATINGS

(75) Inventors: Mohsen Bayati, Salem, MA (US); Mark Braverman, Boston, MA (US); Satyen Chandrakant Kale, Cambridge, MA (US); Yury Makarychev, Cambridge, MA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/362,492

(22) Filed: Jan. 30, 2009

(51) Int. Cl. G06Q 30/00; G06F 7/06; G06F 17/30

(52) U.S. Cl. 705/14.52; 707/E17.014

(57) ABSTRACT

Described is a paid search advertising technology in which ratings values are computed for advertisements (or other web content items) based upon head-to-head evaluations as to which advertisement or advertisements were selected (clicked) from among a set of advertisements that were shown together. Records of a query log contain data of advertisements that were shown together, and each advertisement of those shown together that was clicked. Pairs of advertisements are selected, with the rating value of an advertisement that was clicked increased, and the rating value of the non-clicked advertisement decreased. Only those pairs in which one advertisement was selected and another was not selected may be used as a pair. Elo ratings formulas may be employed for the increasing and decreasing computations. The rating values may be combined with other prediction results into a combined result used to select and/or rank advertisements for returning with a query response.

### BACKGROUND

Most search engines and many websites and are funded by advertisements. For example, when a user submits a search, the resulting response typically includes advertisements.

Although advertisers bid different amounts to have their advertisements appear with respect to keywords, in general, a website is paid by an advertiser only when its advertisement is clicked by a user. As a result, while bidding is one factor in computing revenue, websites also estimate which advertisements are more likely to be clicked with respect to a query, and in general show those advertisements in order to attempt to maximize profit.

Known solutions estimate which advertisement is most likely to be clicked based on the individual features of advertisements and their historical click-through rates. However, such estimates are only predictions that can be improved, and any improvement in estimating which advertisements are more likely to be clicked, and thus generate more revenue, is desirable.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which ratings values are computed for web content items (e.g., advertisements in a paid search system) based upon head-to-head evaluations as to which advertisement or advertisements were selected (clicked) from among a set of advertisements that were shown together. In one aspect, records of a query log are processed, in which each relevant record includes that data that corresponds to a plurality of advertisements that were shown together, and each advertisement of those shown together that was clicked.

In one aspect, the advertisements are processed in selected pairs, in which the rating value of a selected advertisement of the pair is increased, while the rating value of a non-selected advertisement of the pair is decreased. Only those pairs in which one advertisement was selected and another was not selected may be used, e.g., pairs in which both were selected or both not selected may be skipped. In one implementation, Elo ratings formulas are employed for the increasing and decreasing rating value computations.

In one aspect, the rating value associated with an advertisement may be combined with other results, such as based upon bidding keywords and relevance scores. The combined result may be used to select and/or rank advertisements for returning with a query response.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing example components in paid search advertisement system that includes head-to-head ratings for selecting advertisements.

FIG. 2 is a flow diagram showing example steps taken to compute/update ratings values for advertisements within selected pairs of advertisements.

FIG. 3 shows an illustrative example of a computing environment into which various aspects of the present invention may be incorporated.

### DETAILED DESCRIPTION

Various aspects of the technology described herein are generally directed towards predicting which advertisement of a set of possible advertisements is most likely to be clicked, by using head-to-head ratings computed from when those advertisements previously appeared together. The ratings are based upon actual click results that were collected when those advertisements previously were presented together. In general, this technology accounts for relationships and dependencies between advertisements that exist when those advertisements appear together.

In one implementation, a ratings mechanism is based upon the known Elo rating system often used to rate chess opponents. In general, advertisements that are shown together are evaluated in pairs to see which one is clicked (analogous to winning a contest between the two), with a ranking score determined based upon the number of head-to-head clicks. The use of such a head-to-head rating system thus models relationships and dependencies between advertisements, and in practice has been found to noticeably improve the prediction success rate. Note however that head-to-head is not necessarily limited to pairs, e.g., instead of or in addition to pairs, sets of three or even more advertisements (e.g., triplets) may be considered as to which one or ones were clicked and which were not in a given set.

While some of the examples described herein are directed towards an advertising model, other search-related uses for such relative strength ratings are feasible, such as with respect to matching other content items to a query. Further, while the Elo rating system is used as an example, it is understood that any head-to-head rating system, such as one based upon statistics, may be used. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and searching in general.

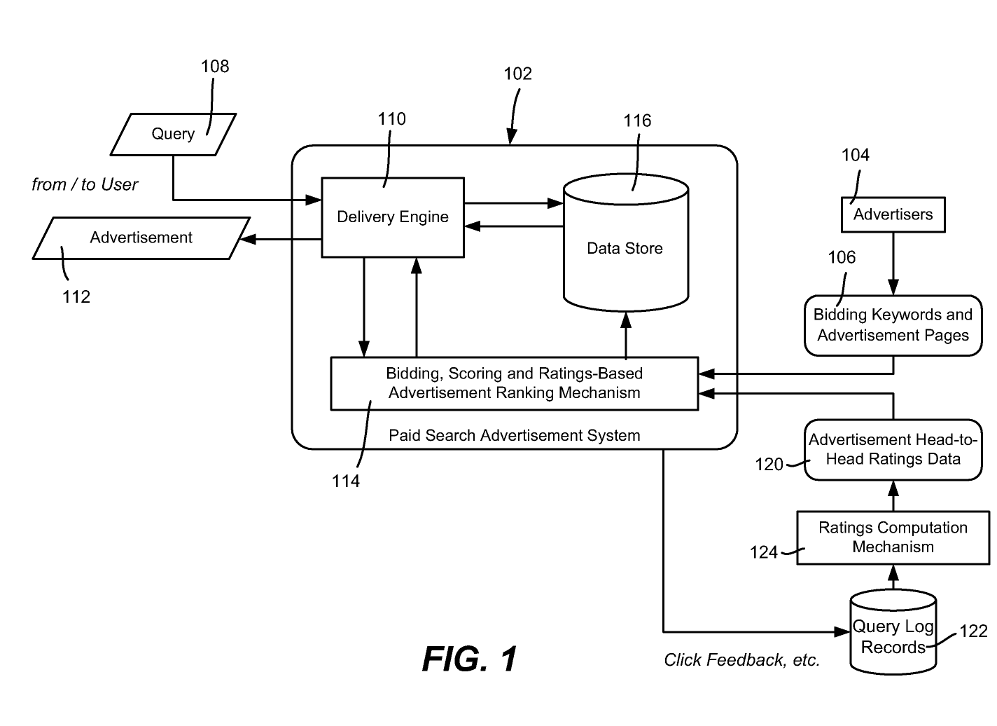

Turning to FIG. 1, there is shown a general block diagram representing example components in a paid search advertisement system 102. In general, advertisers 104 provide advertisements in the form of content pages to the system 102, often along with a bidding keyword comprising one or more terms (typically words; usually advertisers bid a long list of keywords for one advertisement page) that the advertiser wants to match to a query. This is represented in FIG. 1 by the block 106. Thus, for example, one advertiser may agree to pay money to have its advertisement page returned (e.g., directly or as a link thereto) when queries are submitted that match or are similar to the bidding keyword “high resolution digital camera” and so forth.

FIG. 1 also shows such a query 108 being received at a delivery engine 110, resulting in an advertisement 112 returned in response to the query, possibly as a link along with other content, links and/or advertisements. As can be readily appreciated, multiple advertisement links may be ranked in some way based on a scoring system, including based at least in part on a head-to-head rating system as described herein.

For efficiency, the paid search advertisement system 102 typically does not dynamically compute scores for advertisements, but rather pre-computes them offline, for later comparing to queries for selection purposes as a query arrives. A bidding, scoring and ratings-based advertisement ranking mechanism 114 as represented in FIG. 1 may be used for this purpose, basically taking each accepted advertisement and its bidding keyword, computing a relevance score for that advertisement, and storing the advertisement (or pointer thereto), the bidding keyword (e.g., represented as a vector), and relevance score in association with one another in a data store 116. As described herein, a rating value is also maintained in association with each advertisement, as obtained from advertisement head-to-head ratings data 120. Note that the delivery engine 110 also works with the mechanism 114 when selecting an advertisement for a query, however it is understood that such a mechanism 114 may be separated into multiple components, e.g., an offline computation mechanism and a dynamic selection mechanism.

As represented in FIG. 1, the decision on which advertisements to show, and typically in what order to show them, may be influenced by the head-to-head ratings data 120. By way of example, past data may be collected that determines that advertisement A is a relatively strong advertisement in terms of likelihood of being clicked, whereas advertisement B is relatively weak. However, it is not simply click counts that are used, but how those particular advertisements are clicked or not clicked when they appear together.

To compute head-to-head ratings, click data is maintained in query logs 122. The click data includes which advertisements appeared together, and which advertisement was clicked (or advertisements were clicked) when they did. This click data is processed as described herein by a ratings computation mechanism 124 into the head-to-head ratings data 120 for the various advertisements. Note that this head-to-head ratings data 120 may be used in any way, but in one implementation, is used in conjunction with other relevance scoring and bidding data (e.g., scaled and added to existing scores) to select the advertisements.

Each advertisement (or group of similar advertisements such as from one client) thus has a numerical rating value; note that as used herein, “advertisement” thus refers to a single advertisement or any grouping. In general, when multiple advertisements are displayed on a webpage, the rating of those advertisements that were clicked is increased by the ratings computation mechanism 124; the rating of those that were not clicked is decreased.

One type of head-to-head rating system used in the ratings computation mechanism 124 is the Elo rating system. The Elo rating system is typically used to predict the performance of players in chess and some other two-player games. In general, each player has a rating, which corresponds to an estimate of the player's strength. In one implementation, the Elo system, (which may be combined with existing prediction techniques) is used to predict which advertisement is most likely to be clicked. To this end, the advertisements are analogous to game players, their simultaneous appearance in search results is analogous to a tournament match, and when one advertisement is clicked and the other is not, the clicked advertisement is analogous to the tournament match winner and the non-clicked advertisement to the tournament match loser.

Thus, each time several advertisements are shown together, it is assumed that they participate in a competition for a user's attention. Correspondingly, if the user clicks on one (or more) of them, the clicked on advertisement (or advertisements) win in the competition while the others lose.

Note that the Elo scheme was designed to compute rating updates only for two player contests, and is thus is not directly applicable when more than two advertisements are shown together. However, the technology described herein separates the set of advertisements that were shown together into pairs, with the Elo updates computed for each pair of shown advertisements; (note that pairs may be limited to only those in which there is a “clicked” winner and a “non-clicked” loser, that is, ties are not considered). As can be readily appreciated, this ratings computation mechanism 124 based upon pairing and updating ratings is very efficient and can be implemented in large scale systems. Further note that in an alternative system, ties can be considered to some extent, such as to slightly increase the rating of both when both were selected, and slightly decrease the rating of both when both were non-selected.

Thereafter, when the search engine/website selects which advertisements to display for a query, and/or which advertisement to assign to a slot, the prediction based on the head-to-head rating system is used. Typically, it is used in combination with the predictions/results from another existing scheme.

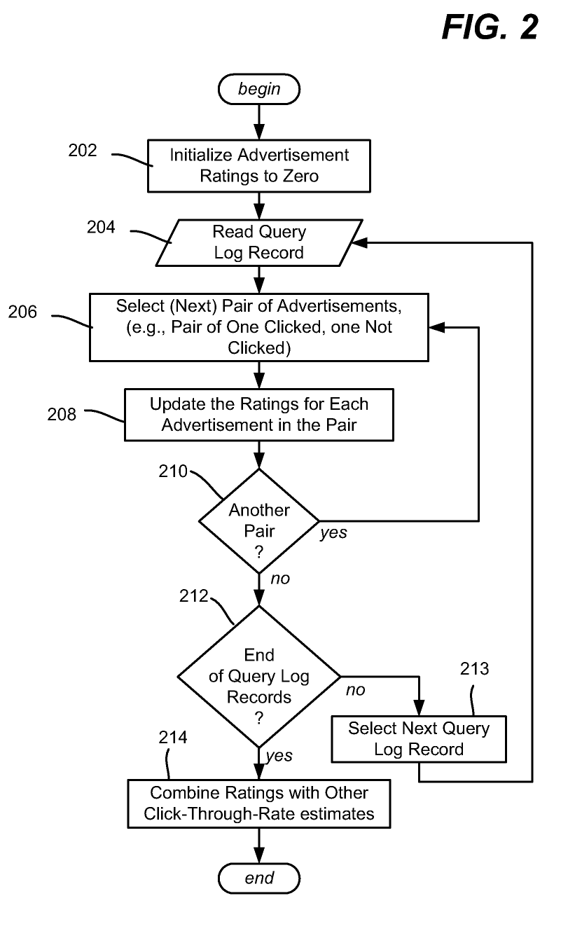

FIG. 2 shows example steps as to how one implementation of such a head-to-head ratings computation process operates. For every possible advertisement A, there is a rating R(A), which may be a real number. Step 202 initializes these ratings to zero; (note that once the ratings are known, new updates to the click information may be applied to update existing ratings, which are then non-zero initial values). The historical data is maintained in a number of query log records that specify, for each search query, which advertisements out of a set of K advertisements displayed were clicked; (typically, K is around ten). Step 204 represents reading a query log record.

Step 206 begins processing the selected query log record to determine which advertisement or advertisements were clicked of those that appeared together. For example, if for a given query record K=4, and advertisements A, B, C, D were shown together and advertisements A and B were clicked on by the user, then advertisements C and D were not clicked. This example query log record implicitly specifies six head-to-head “tournament matches” between advertisements and their results, namely head-to-head tournament matches between all possible pairs, (A, B), (A, C), (A, D), (B, C), (B, D), and (C, D). The results of the head-to-head tournament matches (A, C) and (A, D) have A winning; the results of (B, C) and (B, D) have B winning. This is because in each of these head-to-head tournament matches, one advertisement was clicked while the other was not clicked. The remaining tournament matches are considered ties.

Such head-to-head tournament results are used to update the ratings of each advertisement, which in one implementation is performed using standard Elo formulas as the update rule to update the advertisement ratings. For example, consider the tournament match (A, C) where A wins against C. In an Elo-based system, the ratings are updated for this pairing (at step 208) as follows:

$$R ( A ) ← R ( A ) + c \times \frac{{e}^{R ( C ) - R ( A )}}{1 + {e}^{R ( C ) - R ( A )}}$$

$$R ( C ) ← R ( C ) - c \times \frac{{e}^{R ( C ) - R ( A )}}{1 + {e}^{R ( C ) - R ( A )}}$$

Here, c is a variable parameter (typically on the order of 0.005). Step 210 returns to step 206 so as to repeat the process for any other pairs in the query record that is currently being processed. Note that in this implementation, step 206 does not select ties (such as (A, B)) for processing; only pairs in which one advertisement was clicked and one advertisement was not clicked are selected.

Steps 212 and 213 repeat the ratings processing over the other query log records to update the ratings of these and other advertisements. As can be readily appreciated, updating the ratings is very efficient; as new query logs come in, only the above operations (other than initializing to zero) are needed to update the ratings.

Finally, step 214 adds (or otherwise mathematically combines) the rating, such as scaled by an appropriate constant factor, to already existing click-through-rate estimates. Using the rating in this way improves prediction accuracy; the scaling factor may be tuned or otherwise varied for better results.

As can be seen, there is shown a method and mechanism for improving the quality of estimates of advertisements for click-through-rate (CTR) prediction. Historical information about what advertisements were clicked in response to search queries is processed to compute a rating for each advertisement. This rating may be used in conjunction with already existing click-through-rate prediction schemes to improve the chances of accurately predicting which advertisements will be clicked on in response to future search queries. The prediction is based on correlations among different advertisements shown together, as maintained in historical data to compute the rating.

### Exemplary Operating Environment

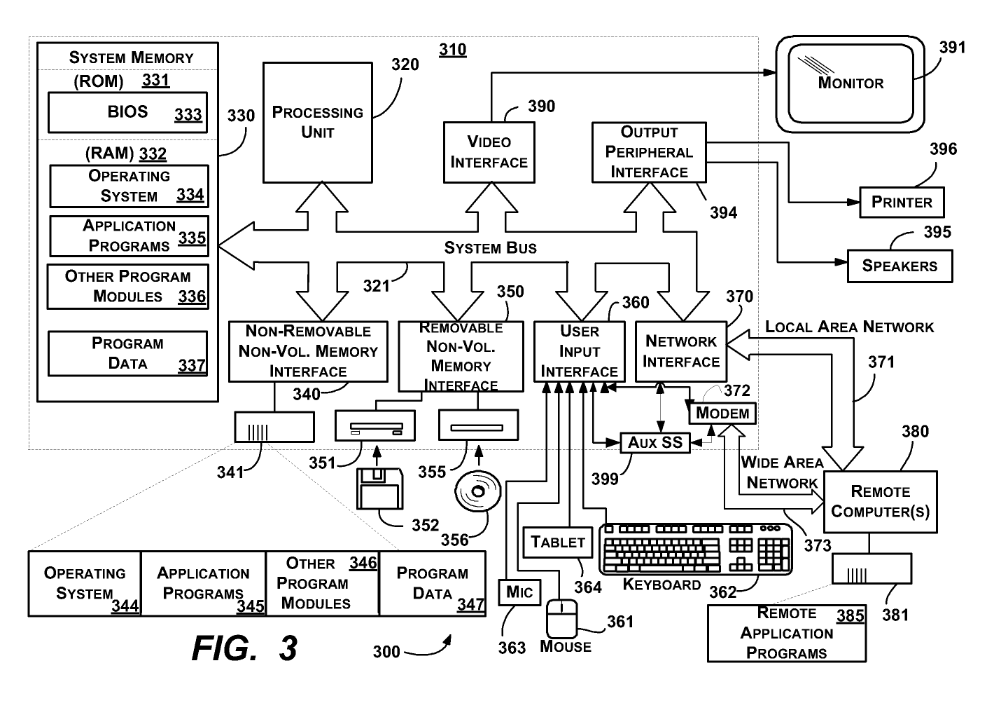

FIG. 3 illustrates an example of a suitable computing and networking environment 300 into which the examples and implementations of any of FIGS. 1-5 may be implemented. The computing system environment 300 is only one example of a suitable computing environment and is not intended to suggest any limitation as to the scope of use or functionality of the invention. Neither should the computing environment 300 be interpreted as having any dependency or requirement relating to any one or combination of components illustrated in the exemplary operating environment 300.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 3, an exemplary system for implementing various aspects of the invention may include a general purpose computing device in the form of a computer 310. Components of the computer 310 may include, but are not limited to, a processing unit 320, a system memory 330, and a system bus 321 that couples various system components including the system memory to the processing unit 320. The system bus 321 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 310 typically includes a variety of computer-readable media. Computer-readable media can be any available media that can be accessed by the computer 310 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 310. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 330 includes computer storage media in the form of volatile and/or nonvolatile memory such as read only memory (ROM) 331 and random access memory (RAM) 332. A basic input/output system 333 (BIOS), containing the basic routines that help to transfer information between elements within computer 310, such as during start-up, is typically stored in ROM 331. RAM 332 typically contains data and/or program modules that are immediately accessible to and/or presently being operated on by processing unit 320. By way of example, and not limitation, FIG. 3 illustrates operating system 334, application programs 335, other program modules 336 and program data 337.

The computer 310 may also include other removable/non-removable, volatile/nonvolatile computer storage media. By way of example only, FIG. 3 illustrates a hard disk drive 341 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 341 is typically connected to the system bus 321 through a non-removable memory interface such as interface 340, and magnetic disk drive 351 and optical disk drive 355 are typically connected to the system bus 321 by a removable memory interface, such as interface 350.

The drives and their associated computer storage media, described above and illustrated in FIG. 3, provide storage of computer-readable instructions, data structures, program modules and other data for the computer 310. In FIG. 3, for example, hard disk drive 341 is illustrated as storing operating system 344, application programs 345, other program modules 346 and program data 347. Note that these components can either be the same as or different from operating system 334, application programs 335, other program modules 336, and program data 337. Operating system 344, application programs 345, other program modules 346, and program data 347 are given different numbers herein to illustrate that, at a minimum, they are different copies. A user may enter commands and information into the computer 310 through input devices such as a tablet, or electronic digitizer, 364, a microphone 363, a keyboard 362 and pointing device 361, commonly referred to as mouse, trackball or touch pad. Other input devices not shown in FIG. 3 may include a joystick, game pad, satellite dish, scanner, or the like. These and other input devices are often connected to the processing unit 320 through a user input interface 360 that is coupled to the system bus, but may be connected by other interface and bus structures, such as a parallel port, game port or a universal serial bus (USB). A monitor 391 or other type of display device is also connected to the system bus 321 via an interface, such as a video interface 390. The monitor 391 may also be integrated with a touch-screen panel or the like. Note that the monitor and/or touch screen panel can be physically coupled to a housing in which the computing device 310 is incorporated, such as in a tablet-type personal computer. In addition, computers such as the computing device 310 may also include other peripheral output devices such as speakers 395 and printer 396, which may be connected through an output peripheral interface 394 or the like.

The computer 310 may operate in a networked environment using logical connections to one or more remote computers, such as a remote computer 380. The remote computer 380 may be a personal computer, a server, a router, a network PC, a peer device or other common network node, and typically includes many or all of the elements described above relative to the computer 310, although only a memory storage device 381 has been illustrated in FIG. 3. The logical connections depicted in FIG. 3 include one or more local area networks (LAN) 371 and one or more wide area networks (WAN) 373, but may also include other networks. Such networking environments are commonplace in offices, enterprise-wide computer networks, intranets and the Internet.

When used in a LAN networking environment, the computer 310 is connected to the LAN 371 through a network interface or adapter 370. When used in a WAN networking environment, the computer 310 typically includes a modem 372 or other means for establishing communications over the WAN 373, such as the Internet. The modem 372, which may be internal or external, may be connected to the system bus 321 via the user input interface 360 or other appropriate mechanism. A wireless networking component 374 such as comprising an interface and antenna may be coupled through a suitable device such as an access point or peer computer to a WAN or LAN. In a networked environment, program modules depicted relative to the computer 310, or portions thereof, may be stored in the remote memory storage device. By way of example, and not limitation, FIG. 3 illustrates remote application programs 385 as residing on memory device 381. It may be appreciated that the network connections shown are exemplary and other means of establishing a communications link between the computers may be used.

An auxiliary subsystem 399 (e.g., for auxiliary display of content) may be connected via the user interface 360 to allow data such as program content, system status and event notifications to be provided to the user, even if the main portions of the computer system are in a low power state. The auxiliary subsystem 399 may be connected to the modem 372 and/or network interface 370 to allow communication between these systems while the main processing unit 320 is in a low power state.

### Conclusion

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents failing within the spirit and scope of the invention.

What is claimed is:

1. In a computing environment, a method comprising:
obtaining head-to-head ratings corresponding to web items that can be selected by a user; and
using the head-to-head ratings in predicting which web item of available web items for output is more likely to be selected by the user.

2. The method of claim 1 wherein the web items comprise advertisements, and wherein using the head-to-head ratings comprises combining a head-to-head-based rating value for each advertisement with a result from another prediction scheme into a combined result.

3. The method of claim 2 further comprising, using the combined result to output advertisements to a user.

4. The method of claim 1 wherein obtaining the head-to-head ratings comprises processing query log records, each query log record representing a plurality of web items that previously appeared together, and which item of the set was selected or which items of the set were selected, when the items were presented together.

5. The method of claim 4 wherein processing the query log records comprises selecting pairs of items from the record for updating, and for each selected pair, updating a rating value associated with each item of the pair based on whether an item was selected or not selected.

6. The method of claim 5 wherein selecting the pairs for updating comprises selecting only pairs in which there is one selected item and one non-selected item.

7. The method of claim 5 wherein updating the rating value comprises increasing the rating value of one item of the pair and decreasing the rating of the other item of the pair when the one item was selected and the other item was not selected.

8. The method of claim 7 wherein increasing the rating value of one item and decreasing the rating of the other item comprises using Elo formulas.

9. In a computing environment, a system comprising, a ratings computation mechanism that processes relevant query log records, each relevant query log record including data corresponding to a plurality of advertisements that were shown together, and which advertisement or advertisements of those shown together that were clicked, the ratings computation mechanism computing a rating value for each advertisement based on head-to-head evaluations of which advertisement or advertisements of those shown together were clicked as indicated in the relevant query log records.

10. The system of claim 9 further comprising a paid search advertisement system that uses the ratings value of each advertisement in determining which advertisement or advertisements to select for returning in response to a query.

11. The system of claim 9 wherein the paid search advertisement system that uses the rating value by mathematically combining the rating value with a result from another scheme.

12. The system of claim 11 wherein the other scheme is based upon bidding keywords or relevance scores, or both bidding keywords and relevance scores.

13. The system of claim 9 wherein the computation mechanism selects data corresponding to pairs of advertisements from each query log record, and updates a rating value associated with each item of the pair based on whether an advertisement was selected or not selected.

14. The system of claim 13 wherein the computation mechanism selects only pairs of advertisements in which there was one selected advertisement and one non-selected advertisement.

15. The system of claim 13 wherein the computation mechanism increases the rating value for a selected advertisement of the pair and decreases the rating of a non-selected item of the pair.

16. The system of claim 13 wherein the computation mechanism includes an Elo-based ratings mechanism.

17. One or more computer-readable media having computer-executable instructions, which when executed perform steps, comprising: processing relevant query log records, each relevant record including information as to advertisements that were shown together, and information as to each advertisement of those shown together that was selected, the processing including selecting pairs of advertisements, increasing a rating value associated with one advertisement of the pair when that advertisement was selected, and decreasing a rating value associated with another advertisement of the pair when that other advertisement was not selected.

18. The method of claim 5 wherein selecting the pairs for comprises selecting only pairs in which there is one selected item and one non-selected item.

19. The one or more computer-readable media of claim 17 having further computer-executable instructions comprising, combining the rating value of an advertisement with a result from another scheme into a combined result that is used in selecting advertisements for a query response.

20. The one or more computer-readable media of claim 18 wherein increasing the rating value of one advertisement and decreasing the rating of the other advertisement comprises using Elo formulas.
